(19) United States
(12) Patent Application Publication
(10) Pub. No.: US 2008/0101301 A1
(43) Pub. Date: May 1, 2008

(54) HANDOVER IN A CELLULAR COMMUNICATION SYSTEM

(75) Inventors: Howard J. Thomas, Cirencester (GB); Gerard T. Foster, Swindon (GB); Trevor T. Hanna, Dowdeswell (GB); Subramanian S. Iyer, Mundelein, IL (US); Luis Lopes, Swindon (GB)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/553,488

(22) Filed: Oct. 27, 2006

(51) Int. Cl. H04B 7/216

(52) U.S. Cl. 370/335

(57) ABSTRACT

A cellular communication system includes base stations supporting macro cells and with unique cell scrambling codes within a region. The system further includes access points supporting underlay cells and with shared cell scrambling codes within the region. One or more of the access points or base stations comprise transmit means for transmitting an indication of at least a first shared scrambling code to a remote station. The shared scrambling code is shared by a plurality of access points. The remote station is arranged to receive the first shared scrambling code and to determine if a first signal using the first shared scrambling code is received. If the first signal is detected, a handover controller initiates a handover of the remote station to at least a first access point of the plurality of access points sharing the first shared scrambling code.

### FIELD OF THE INVENTION

The invention relates to handover in a cellular communication system and in particular, but not exclusively, to handover to underlay cells in a Code Division Multiple Access (CDMA) cellular communication system.

### BACKGROUND OF THE INVENTION

A method which has been used to increase the capacity of cellular communication systems is the concept of hierarchical cells wherein a macrocell layer is underlayed by a layer of typically smaller cells having coverage areas within the coverage area of the macrocell. In this way, smaller cells, known as microcells or picocells (or even femtocells), are located within larger macrocells. The microcells and picocells have much smaller coverage thereby allowing a much closer reuse of resources. Frequently, the macrocells are used to provide coverage over a large area, and microcells and picocells are used to provide additional capacity in e.g. densely populated areas and hotspots. Furthermore, picocells can also be used to provide coverage in specific locations such as within a residential home or office.

In order to efficiently exploit the additional resource, it is important that handover performance between the macrocell layer and the underlying layer is optimised. The process of handover can be separated into three phases. Firstly, identifying that a handover might be required, secondly, identifying a suitable handover candidate and finally, switching the mobile user from one base station to another.

Currently 3^{rd} generation (3G) cellular communication systems based on Code Division Multiple Access (CDMA) technology (such as the Universal Mobile Telecommunication System (UMTS)) are being deployed. In these systems, each cell is allocated a unique scrambling code which is used to spread the air interface signals in order to provide cell separation. The User Equipments (UEs) of such systems receive a neighbour list identifying a number of scrambling codes for neighbour cells and the UEs apply the neighbour scrambling codes to the received signal in order to measure receive levels. The signal level for each neighbour scrambling code is measured and reported back to the network. The network then uses these measurements to determine if a handover should be performed, and if so to which cell the UE should be handed over.

The current trend is moving towards introducing a large number of picocells to 3G systems. For example, it is envisaged that residential access points may be deployed having only a target coverage area of a single residential dwelling or house. A widespread introduction of such systems would result in a very large number of small underlay cells within a single macrocell.

However, underlaying a macrolayer of a 3G network with a picocell (or microcell) layer creates several issues for the management of handovers of UEs between the different layers. In particular, 3G communication systems are developed based on each cell having a relatively low number of neighbours and extending the current approach to scenarios wherein the UE may need to consider large numbers of potential neighbour cells is not practical.

One problem of extending current approaches to scenarios where there are many underlaying picocells is how to uniquely and efficiently identify a picocell (or microcell). Specifically, it is not practically feasible to list every underlay cell as a potential neighbour of the macrocell as this would require very large neighbour lists. These large neighbour lists would e.g. result in the neighbour list exceeding the maximum allowable number of neighbours in the list, slow UE measurement performance as a large number of measurements would need to be made. It would furthermore require significant operations and management resource in order to configure each macrocell with a large number of neighbours.

Hence, an improved system for handover in a cellular communication system would be advantageous and in particular a system allowing increased flexibility, improved suitability for large numbers of potential handover target cells, improved suitability for underlay/overlay handovers, reduced neighbour lists, increased practicality, reduced measurement requirements and/or improved performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a cellular communication system including a number of base stations supporting macro cells and with unique cell scrambling codes within a region and a number of access points supporting underlay cells and with shared cell scrambling codes within the region, the cellular communication system comprising; at least one access point or base station comprising transmit means for transmitting an indication of at least a first shared scrambling code to a remote station, the shared first scrambling code being shared by a plurality of access points; the remote station being arranged to receive the indication of the first shared scrambling code and to determine if a first signal using the first shared scrambling code is received; and handover means for, if the first signal is detected, handing the remote station over to at least a first access point of the plurality of access points sharing the first shared scrambling code.

The invention may allow improved handover in a cellular communication system. In particular, the invention may facilitate or improve handovers in systems wherein a remote station may have a large number of potential handover targets. In particular, the invention may allow a reduced number of measurements being required by a remote station to determine a suitable handover target, may allow reduced neighbour lists and/or may reduce the required number of scrambling codes.

The access points may specifically be base stations of underlay cells to a macrocell layer supported by the base stations with unique scrambling codes within a given region. The underlay cells may e.g. be micro-, pico- and/or femto-cells. The remote station may for example be a User Equipment or a mobile communication unit, e.g. of a 3^{rd} generation cellular communication system such as UMTS.

The region may for example be a reuse region for scrambling codes. In some cases, the region may be dynamically defined by the neighbour list of a given base station or base station(s). Thus, the base station scrambling codes are unique within the coverage area defined by the neighbour list (such as the area defined by the coverage area of the serving cell and the coverage area of the neighbour cells identified by the neighbour cell). Within the region the base station cell scrambling codes are unique whereas at least two access points for underlay cells share a common cell scrambling code.

According to an optional feature of the invention, the remote station is arranged to transmit an indication of the detection of the first signal to a fixed network of the cellular communication system; and the fixed network comprises identifying means for identifying the first access point from the plurality of access points sharing the first shared scrambling code.

This may facilitate implementation and/or improve performance. The identifying means may for example be located in the Radio Access Network or Core Network of a 3^{rd} generation cellular communication system such as UMTS. The identifying means may specifically be implemented in a Radio Network Controller (RNC) or a Mobile Switching Center (MSC).

According to a different aspect of the invention, there is provided a method of operation for a cellular communication system including a number of base stations supporting macro cells and with unique cell scrambling codes within a region and a number of access points supporting underlay cells and with shared cell scrambling codes within the region, the method comprising; at least one access point or base station transmitting an indication of at least a first shared scrambling code to a remote station, the first shared scrambling code being shared by a plurality of access points; the remote station receiving the indication of the first shared scrambling code; the remote station determining if a first signal using the first shared scrambling code is received; and if the first signal is detected, handing the remote station over to at least a first access point of the plurality of access points sharing the first shared scrambling code.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a cellular communication system in accordance with some embodiments of the invention;

FIG. 2 illustrates exemplary elements of a UMTS cellular communication system in accordance with some embodiments of the invention; and

FIG. 3 illustrates an example of a method of operation for a cellular communication system in accordance with some embodiments of the invention.

### DETAILED DESCRIPTION OF SOME EMBODIMENTS OF THE INVENTION

The following description focuses on embodiments of the invention applicable to a CDMA cellular communication system and in particular to a 3^{rd} Generation Cellular communication system such as a UMTS System. However, it will be appreciated that the invention is not limited to this application but may be applied to many other communication systems.

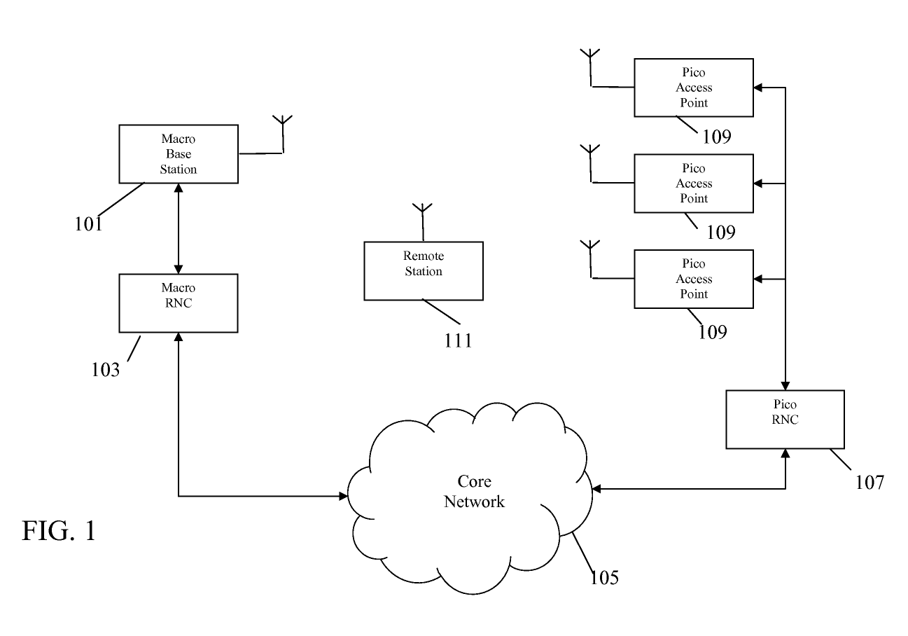

FIG. 1 illustrates an example of a cellular communication system in accordance with some embodiments of the invention. In the system, a macro-layer is formed by macrocells supported by base stations. Furthermore, an underlay layer of picocells are supported by a large number of access points corresponding to picocell base stations. Specifically, each access point may have an intended coverage of a single house or dwelling, and for a typical macrocell coverage area of 10 to 30 km there may be hundreds or even thousands of picocells each supported by an individual access point.

In the system, the macro base stations each have a cell separation code in the form of a scrambling code which is unique within a given region which e.g. may be a reuse area for the cell scrambling codes. Specifically the macro base stations have an assigned scrambling code which is unique within the reuse area such that a set of defined neighbours for each cell always have unique cell scrambling codes. Accordingly, the neighbour lists transmitted by the base stations comprise indications of macro-cells which all have different cell scrambling codes. In contrast, the access points use a scrambling code which is shared between a plurality of access points within the reuse area and specifically a given neighbour list may comprise indications of shared cell scrambling codes for a plurality of underlay cells that are all considered as neighbours/potential handover targets for the current cell. By sharing a scrambling code between a plurality of access points, a much reduced number of scrambling codes are required by the system. Furthermore, by keeping the number of scrambling codes low, the number of scrambling codes that must be evaluated by the remote station for handover determination can be reduced substantially thereby reducing the measurement time, power consumption and/or complexity of the remote station.

In some embodiments, all access points within a coverage area supported by simple macro RNC use the same scrambling code. However, it will be appreciated that in other embodiments, a plurality of shared scrambling codes may be available for the access points. Therefore, the access points may be divided into a number of groups with the access points of each group sharing a scrambling code but with different scrambling codes being used for different groups. In such embodiments, the scrambling codes may be allocated to the access points such that a reuse pattern is established with the interference between picocells having the same shared scrambling code being reduced or minimised.

FIG. 1 illustrates one macro-base station 101 which supports a macrocell with a typical coverage area of 10-30 kilometres. The macro base station 101 is coupled to a macro RNC 103 which is furthermore coupled to other macro base stations (not shown). The macro RNC 103 is furthermore coupled to a core network 105 which interfaces to other radio access networks and RNCs. In particular, the core network 105 is coupled to a pico-RNC 107. The pico-RNC 107 is coupled to a plurality of access points 109 (of which three are shown in FIG. 9). Each of the access points 109 supports a picocell having a coverage area of typically 10 to 50 meters. The access points 109 implement the required functionality of a UMTS base station in order to support UMTS communications within the picocell. However, in contrast to conventional UMTS base stations, the access points 109 use a common shared scrambling code.

In some embodiments, the same shared scrambling codes may be used by access points coupled to different pico-RNCs.

In some embodiments, the access points 109 may additionally have an assigned unique scrambling code within the region. However, in the described embodiments the access points 109 do not have a unique scrambling code but only use the common shared scrambling code for cell separation.

In the example, a remote station 111 is located within the macrocell of the macro base station 101 and is currently supported by the macro base station 101. However, if the remote station 111 detects the presence of a picocell it will perform a handover to the corresponding access point 109.

In order to determine whether a picocell is present, the macro base station 101 transmits a neighbour list which includes an indication of the shared scrambling code of the access points 109. Accordingly, the remote station 111 continuously monitors for the presence of a pilot signal using the shared scrambling code. As all the picocells share the same scrambling code, only a single scrambling code needs to be included in the neighbour list and the remote station 111 needs only to monitor for one specific scrambling code.

Thus, if the remote station 111 detects a sufficiently strong received signal level for the shared scrambling code, it generates a measurement report indicating that a shared scrambling code has been identified. The measurement report is transmitted to the macro base station 101 which forwards it to the macro RNC 103.

In a typical scenario, the picocells are not overlapping but rather form a pattern of individual islands of coverage within the coverage area of the macrocell. Accordingly, when the remote station 111 detects the presence of a shared scrambling code it is likely to indicate that the remote station 111 has entered the coverage area of a picocell (e.g. the remote station has moved into a house covered by a single local access point). As the interference between different access points is low, this is a strong indication that the access point can efficiently support the communication of the remote station 111. Accordingly, the system will seek to handover the remote station 111 to the detected picocell.

It will be appreciated, that even in embodiments wherein a large number of overlapping picocells are present, islands of coverage scenarios for the individual shared scrambling codes can be achieved by using a plurality of shared scrambling codes assigned in a suitable reuse pattern.

The described approach provides an efficient and low resource demanding method of detecting the presence of a suitable picocell handover target. However, as a consequence of using a shared scrambling code, the detection of such a code only indicates the presence of a suitable handover target but does not provide the identity of this handover target.

Various ways of identifying the target access point can be used. In the following, an approach based on identification in the macro RNC 103 will be described.

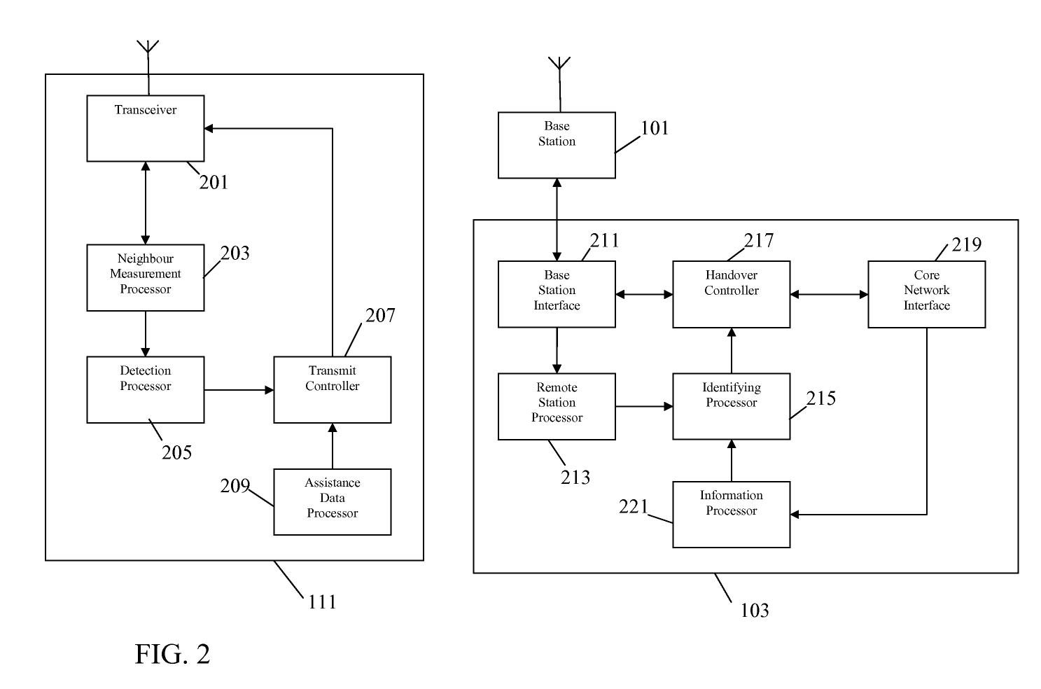

FIG. 2 illustrates elements of a UMTS cellular communication system in accordance with some embodiments of the invention.

As illustrated in FIG. 2, the remote station 111 comprises a transceiver 201 which is operable to communicate with the base station 101 over the air interface in accordance with the Technical Specifications for UMTS.

The transceiver 201 is coupled to a neighbour measurement processor 203 which is arranged to receive the neighbour list broadcast by the base station 101. The neighbour measurement processor 203 furthermore controls the transceiver 201 to perform receive level measurements for the scrambling codes of the neighbour list. The neighbour measurement processor 203 is coupled to a detection processor 205 which is arranged to detect if the shared scrambling code of the picocells has been received. In particular, the detection processor 205 measures the received level for the shared scrambling code and compares this to a predetermined threshold. If the receive level exceeds the predetermined threshold, the presence of the shared scrambling code is considered to have been detected.

In some embodiments, a dynamic threshold may be used. For example, the threshold may be dependent on other measured levels. Also the level compared to the threshold may not be an absolute value but may e.g. be a ratio such as a signal to noise ratio.

The detection processor 205 is coupled to a transmit controller 207 which, in response to the detection of the shared scrambling code, generates a detection message which is transmitted by the transceiver 201 to the base station 101 which forwards it to the RNC 103.

In the example, the remote station 111 furthermore comprises an assistance data processor 209 which is arranged to include additional data in the detection message sent to the RNC 103. In particular, the assistance data processor 209 can comprise a GPS receiver which determines the geographical location of the remote station 111 when the shared scrambling code is detected. An indication of this location can then be included in the detection message transmitted to the RNC 103.

The RNC 103 comprises a base station interface 211 which is arranged to communicate with the base station 101. The base station interface 211 is coupled to a remote station processor 213 which receives the detection message transmitted by the remote station 111.

The remote station processor 213 is coupled to an identifying processor 215 which proceeds to identify a target access point out of the plurality of access points that use the shared scrambling code detected by the remote station 111.

In the example, the identifying processor 215 uses the location information provided by the remote station 111 to determine which of the access point 109 has been detected. Specifically, the identifying processor 215 comprises a look-up table containing the location and unique identifier (or address) for each of the access points 109. The identifying processor 215 accordingly determines the access point 109 which is closest to the current location of the remote station 111 and retrieves the corresponding identifier.

The identifying processor 215 is coupled to a handover controller 217 which is provided with the identifier of the target access point 109. The handover controller 217 is coupled to the base station interface 211 and to a core network interface 219 which is operable to interface the RNC 103 to the core network 105. Upon receiving the identifier, the handover controller 217 proceeds to initiate a handover of the remote station 111 to the identified access point 109.

In particular, the handover controller 217 generates a relocation request message which is transmitted to the identified access point 109 by the core network interface 219. If the identified access point 109 accepts the relocation request, it transmits a relocation acknowledgement message back to the RNC 103. In response, the handover controller 217 generates a handover command message which is transmitted to the remote station 111 by the base station 101. When the remote station 111 receives the handover command, it proceeds to a handover to the identified access point using conventional UMTS handover procedures.

In some embodiments, the determination of the detected access point may be performed remotely from the RNC 103. In particular, the RNC 103 may provide a remote identifying processor with one or more attributes currently associated with the remote unit within the cellular network, such as current cell identification, current RNC identification, location area code or identification, or others used within cellular systems. The identifying processor 215 uses these attributes to determine, in isolation or in conjunction with other information, the identity of the most likely access point.

In some embodiments, the RNC 103 may initiate a relocation request without first identifying the access point. The relocation request contains all information gathered by the RNC, and is routed to a remote identifying processor. The remote identifying processor uses the information contained within the relocation request to identify the target access point, and generates a modified relocation request to that access point.

In some embodiments, the assistance data processor 209 may be arranged to additionally or alternatively transmit an identification of the remote station 111 to the RNC 103. For example, the assistance data processor 209 may include the IMSI (International Mobile Subscriber Identity) of the remote station 111 in the detection message sent to the remote station processor 213.

In some UMTS systems, the RNC may not have information of the IMSIs of the supported remote stations, and the remote station providing this results in an efficient way of the identifying processor 215 obtaining the information. Consequently, the identification of the target access point can be in response to the IMSI. For example, the identifying processor 215 may comprise a look-up table which for various remote station identities indicates one or more allowable access points, and the identifying processor 215 can simply select one of these access points as the target access point for the handover.

In some embodiments, the RNC 103 furthermore comprises an information processor 221 coupled to the core network interface 219 and the identifying processor 215. The information processor 221 may receive subscription information from the core network for the individual supported remote station. For example, whenever a new call is set up for a remote station served by the RNC 103, the core network may transmit an information message to the RNC 103 which includes subscription data for the remote station. The information message may specifically be a UMTS Common Identity message or a RANAP (Radio Access Network Application Part) message.

The subscription data can include an identification of specific access points that may be used by the remote station and/or can indicate whether the remote station is allowed to use the picocell layer at all. As a specific example, a user may have an access point installed in his home and may subscribe to low-cost calls when at home and using this access point. However, the access point may only be allowed to be used by users which have specifically subscribed to this access point (e.g. only the residents of the house). Thus, in this example, a user must explicitly subscribe to an access point in order to be able to use it. Hence, for each remote station setting up a call, the core network may download an identification of the access point(s) that may be used by the remote station to the information processor 221. When the identifying processor 215 receives the detection message from the remote station 111 it retrieves the subscription information from the information processor 221. If the information indicates that the remote station 111 is only allowed to use a specific access point, the identifier of this access point is forwarded to the handover controller 217 which accordingly proceeds to attempt a handover of the remote station 111 to the identified access point.

In such an example, it is possible that the target access point identified by the identifying processor 215 is different than the access point which was actually detected by the remote station 111. However, in such a case the handover attempt will simply fail and the remote station 111 will remain on the macrocell.

In some embodiments, the remote station 111 may alternatively or additionally comprise functionality for identifying which of the access points sharing a scrambling code has been detected. Specifically, the remote station 111 may upon the detection of the shared scrambling code proceed to try and decode the received signal in order to extract information data transmitted by the access point 109.

Specifically, the access points 109 may continuously transmit a broadcast channel using the shared scrambling code. The broadcast channel can in addition to the scrambling code also be spread by use of a channelisation code. Hence by applying both the channelisation and scrambling code to the received signal, the remote station 111 can decode the data transmitted on the broadcast channel. This broadcast channel will typically include a unique identifier of the access point. Thus, when transmitting the detection message to the RNC 103, the remote station 111 can also include a unique identifier of the detected access point and the handover controller 217 can proceed to initiate the handover to this access point.

Specifically, for a UMTS communication system, each access point may transmit a Broadcast CHannel (BCH) and the remote station 111 can be arranged to decode the Base Station Identity Code (BSIC) from the BCH. The remote station 111 may for example use compressed mode to simultaneously receive signals from the serving macro base station and the detected access point.

In the above examples, the information of the shared scrambling codes was transmitted to the remote stations using a broadcast message including the neighbour list. In other embodiments, information of the shared scrambling codes may alternatively or additionally be transmitted to remote stations using dedicated messages. The dedicated messages are specifically addressed to a remote station or a specific group of remote stations.

Thus, the use of dedicated messages allows the system to control the measurement operations of each remote station such that it can be targeted for the current situation. This may be particularly useful in situations where a plurality of shared scrambling codes are used within a macrocell. In this case, the individual remote station can be limited to only search for one shared scrambling code out of the plurality of shared scrambling codes.

For example, the RNC 103 can comprise functionality for generating a dedicated message that can be transmitted to the remote station 111. The dedicated message comprises an indication of a shared scrambling code and in response to receiving the message, the remote station 111 will include this shared scrambling code in the set of scrambling codes to monitor.

The customisation of the shared scrambling codes to the remote stations may for example be performed in response to the locations of the remote stations. For example, if the location of the remote station 111 is known, the RNC 103 may determine which access point(s) is(are) close to the remote station 111 and include the scrambling code of this (these) access point(s) in the dedicated message.

Alternatively or additionally, the dedicated message may be generated in response to a serving base station for the remote stations. For example, the remote station 111 is served by the macro base station 101 and the RNC 103 may determine which shared scrambling codes are used within the cell of the macro base station 101. Accordingly, these scrambling codes can be transmitted to the remote station 111.

In some embodiments, the dedicated message is generated in response to subscription information for the remote station. E.g. in the previous example where each user explicitly subscribes to one access point, the RNC 103 may use subscription information to determine which access points the remote station is subscribed to. It may then include the scrambling codes of these access points in a dedicated message transmitted to the remote station 111. As in the previous example, the subscription information may be received from the core network at call setup e.g. in a UMTS Common Identity message or a RANAP message.

In some embodiments, the dedicated message may be generated in response to a combination of the subscription and location information of the remote station.

It will be appreciated that although the above description has focussed on various embodiments wherein much of the functionality is implemented in an RNC, the functionality may be implemented partly or fully in other entities in other embodiments. In particular, the target identification and/or handover functionality may be implemented in any entity which comprises all or part of the Radio Resource Control functionality for the air interface. For example, the functionality may be implemented in e.g. a base station, an access gateway or a UMA (Unlicensed Mobile Access) Network Controller (UNC).

It will be appreciated that although the above description has focussed on the transmission of the indication of the shared scrambling code(s) from the base station, the information may alternatively or additionally be transmitted by one or more of the access points.

It will also be appreciated that although the previous description has focused on scenarios where the handovers of active calls are controlled by an RNC, the described approach and principles are not limited to this scenario. For example, the handover control functionality may instead be located in the remote station which may autonomously decide to handover to an access point. For example, upon the detection of a shared scrambling code and after decoding of the BSIC from the BCH, the remote station may directly proceed to transmit access requests to the identified target access point without communicating with the RNC. Such an approach may specifically be suitable for a remote station in idle mode. Thus, the remote station may simply perform a serving cell reselection based on the detection of a shared scrambling code.

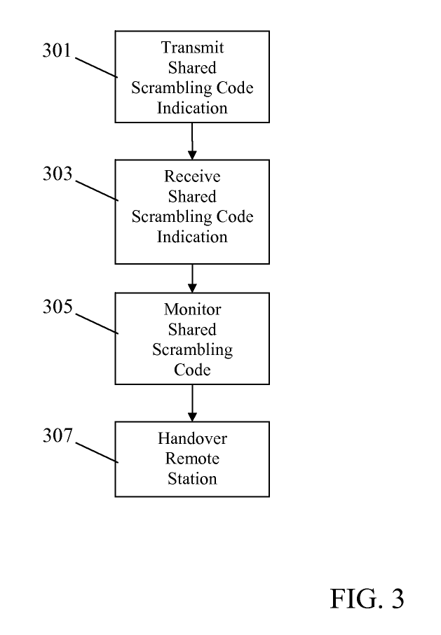

FIG. 3 illustrates an example of a method of operation for a cellular communication system in accordance with some embodiments of the invention. The cellular communication system includes a number of base stations supporting macro cells and with unique cell scrambling codes within a region. The system also includes a number of access points supporting underlay cells and with shared cell scrambling codes within the region.

The method initiates in step 301 wherein at least one access point or base station transmits an indication of at least a first shared scrambling code to a remote station. The shared scrambling code is shared by a plurality of access points.

Step 301 is followed by step 303 wherein the remote station receives the indication of the first shared scrambling code.

Step 303 is followed by step 305 wherein the remote station determines if a first signal using the first shared scrambling code is received.

Step 305 is followed by step 307 wherein, if the first shared scrambling code is detected, the remote station is handed over to at least a first access point of the plurality of access points sharing the first shared scrambling code.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims does not imply any specific order in which the features must be worked and in particular the order of individual steps in a method claim does not imply that the steps must be performed in this order. Rather, the steps may be performed in any suitable order.

1. A cellular communication system including a number of base stations supporting macro cells and with unique cell scrambling codes within a region and a number of access points supporting underlay cells and with shared cell scrambling codes within the region, the cellular communication system comprising;
at least one access point or base station comprising transmit means for transmitting an indication of at least a first shared scrambling code to a remote station, the shared first scrambling code being shared by a plurality of access points;
the remote station being arranged to receive the indication of the first shared scrambling code and to determine if a first signal using the first shared scrambling code is received; and
handover means for, if the first signal is detected, handing the remote station over to at least a first access point of the plurality of access points sharing the first shared scrambling code.

2. The cellular communication system of claim 1 further comprising means for identifying the first access point from the plurality of access points sharing the first shared scrambling code in response to a location of the remote station.

3. The cellular communication system of claim 1 wherein the remote station is arranged to transmit an indication of the detection of the first signal to a fixed network of the cellular communication system; and the fixed network comprises identifying means for identifying the first access point from the plurality of access points sharing the first shared scrambling code.

4. The cellular communication system of claim 3 wherein the identifying means furthermore comprises means for transmitting a handover request message to the first access point.

5. The cellular communication system of claim 3 further comprising a Radio Network Controller, RNC, arranged to receive the indication of the detection of the first signal from the remote station and to transmit an instigate handover message to the identifying means, the instigate handover message not comprising an identification of the first access point and the identifying means being remote from the RNC.

6. The cellular communication system of claim 3 wherein the remote station is further arranged to transmit a location indication for the remote station in response to detecting the first signal; and the identifying means is arranged to identify the first access point in response to the location indication.

7. The cellular communication system of claim 3 wherein the identifying means is comprised in a Radio Network Controller, RNC.

8. The cellular communication system of claim 7 wherein the remote station is further arranged to transmit a remote station identity to the RNC in response to detecting the first signal.

9. The cellular communication system of claim 3 wherein the identifying means is arranged to identify the first access point in response to a subscription characteristic of the remote station.

10. The cellular communication system of claim 9 further comprising means for transmitting subscription data from a core network of the cellular communication system to the identifying means at call establishment.

11. The cellular communication system of claim 1 wherein the remote station comprises identifying means for uniquely identifying the first access point from the plurality of access points sharing the first shared scrambling code, the identifying means comprising:
means for, in response to detecting the first signal, receiving cell broadcast information signals from at least one access point;
means for determining a cell identity of the cell from the cell broadcast information signal; and
means for determining the first access point in response to the cell identity.

12. The cellular communication system of claim 1 wherein the transmit means is arranged to transmit the indication of the first shared scrambling code in a broadcast message.

13. The cellular communication system of claim 1 wherein the transmit means is arranged to transmit the indication of the first shared scrambling code in a dedicated message.

14. The cellular communication system of claim 13 wherein the transmit means further comprises means for transmitting the dedicated message in response to evaluation of a parameter selected from the group of parameters consisting of:
a location parameter for the first remote station;
a serving base station for the first remote station; and
subscription information for the first remote station.

15. The cellular communication system of claim 13 further comprising means for transmitting subscription data from a core network of the cellular communication system to the transmit means at call establishment.

16. The cellular communication system of claim 15 wherein the subscription information data is included in a 3^{rd} Generation Partnership Project, 3GPP, Common Identity message or a Radio Access Network Application Part, RANAP, message.

17. The cellular communication system of claim 1 wherein the remote station comprises means for transmitting an access request to the first access point in response to detecting the first signal.

18. The cellular communication system of claim 1 wherein cell scrambling codes of base stations of neighbour lists transmitted by the base stations are unique.

19. The cellular communication system of any previous claim wherein the cellular communication system is a Universal Mobile Telecommunication System.

20. A method of operation for a cellular communication system including a number of base stations supporting macro cells and with unique cell scrambling codes within a region and a number of access points supporting underlay cells and with shared cell scrambling codes within the region, the method comprising the steps of;
at least one access point or base station transmitting an indication of at least a first shared scrambling code to a remote station, the first shared scrambling code being shared by a plurality of access points;
the remote station receiving the indication of the first shared scrambling code;
the remote station determining if a first signal using the first shared scrambling code is received; and
if the first signal is detected, handing the remote station over to at least a first access point of the plurality of access points sharing the first shared scrambling code.
